(19) United States
(12) Patent Application Publication
(10) Pub. No.: US 2017/0241166 A1
(43) Pub. Date: Aug. 24, 2017

(54) CHARGING CART

(71) Applicant: AVer Information Inc., New Taipei City (TW)

(72) Inventor: Ming-Te Cheng, New Taipei City (TW)

(21) Appl. No.: 15/155,740

(22) Filed: May 16, 2016

(30) Foreign Application Priority Data
Feb. 24, 2016 (TW) TW 105105476

(51) Int. Cl. E05B 65/06; E05C 7/04; A47B 81/00; E05C 9/18; E05C 3/00; E05B 57/00; E05C 9/08

(52) U.S. Cl. CPC E05B 65/06; E05B 57/00; E05C 7/04; E05C 9/08; E05C 9/18; E05C 3/006; A47B 81/00

(57) ABSTRACT

A charging cart includes a casing, at least one door leaf and a hooking mechanism. The casing has at least one first hooking slot. The door leaf is pivotally mounted to the casing so that the door leaf is rotatable relative to the casing about a first rotation axis. The hooking mechanism includes a movable assembly and at least one hooking member. The movable assembly is movably disposed on the door leaf. The hooking member is connected to the movable assembly. The hooking member is driven by the movable assembly to rotate relative to the door leaf about a second rotation axis to be moved between a locked position and an unlocked position. The second rotation axis is parallel to the first rotation axis.

### CROSS-REFERENCE TO RELATED APPLICATIONS

This non-provisional application claims priority under 35 U.S.C. §119(a) to Patent Application No(s). 105105476 filed in Taiwan, R.O.C. on Feb. 24, 2016, the entire contents of which are hereby incorporated by reference.

### TECHNICAL FIELD

The disclosure relates to a charging cart, more particularly to a charging cart for accommodating a plurality of electronic devices.

### BACKGROUND

In recent years, portable electronic devices such as tablet computers, notebook computers and smart phones are widely used in learning and teaching activities. In order to store a large amount of the portable electronic devices, a charging cart allowing the portable electronic devices to charge and store is provided.

### SUMMARY

The present disclosure provides a charging cart for solving the problem that the conventional charging cart is easily deformed during locking the door leaf.

One embodiment of the disclosure provides a charging cart including a casing, at least one door leaf and a hooking mechanism. The casing has at least one first hooking slot. The door leaf is pivotally mounted to the casing so that the door leaf is rotatable relative to the casing about a first rotation axis. The hooking mechanism includes a movable assembly and at least one hooking member. The movable assembly is movably disposed on the door leaf. The hooking member is connected to the movable assembly. The hooking member is driven by the movable assembly to rotate relative to the door leaf about a second rotation axis to be moved between a locked position and an unlocked position. The second rotation axis is parallel to the first rotation axis. When the hooking member is at the locked position, the hooking member hooks into the first hooking slot of the casing so that the door leaf is fixed to the casing. When the at least one hooking member is moved from the locked position to the unlocked position by the movable assembly, the hooking member rotates and is detached from the first hooking slot of the casing so that the door leaf is rotatable relative to the casing.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIGS. 1A and 1B are perspective views of a charging cart according to one embodiment of the disclosure;

FIG. 2 is a partial enlarged exploded view of the charging cart in FIG. 1B;

FIG. 3A is a perspective view of an hooking member at a locked position according to one embodiment of the disclosure; and

FIG. 3B is a perspective view of the hooking member at an unlocked position according to one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

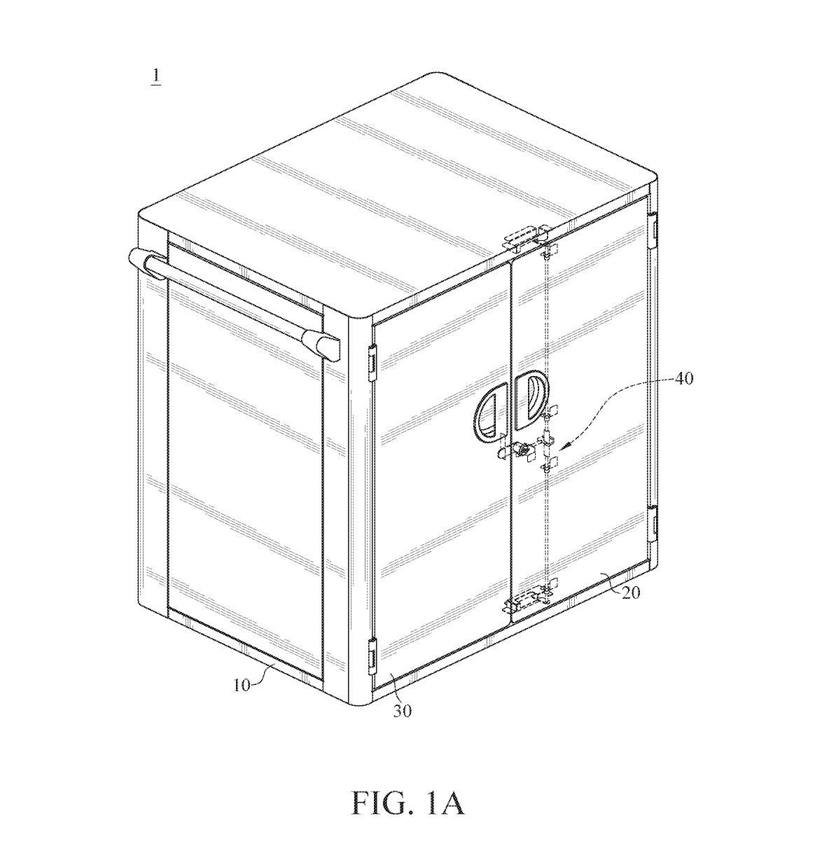

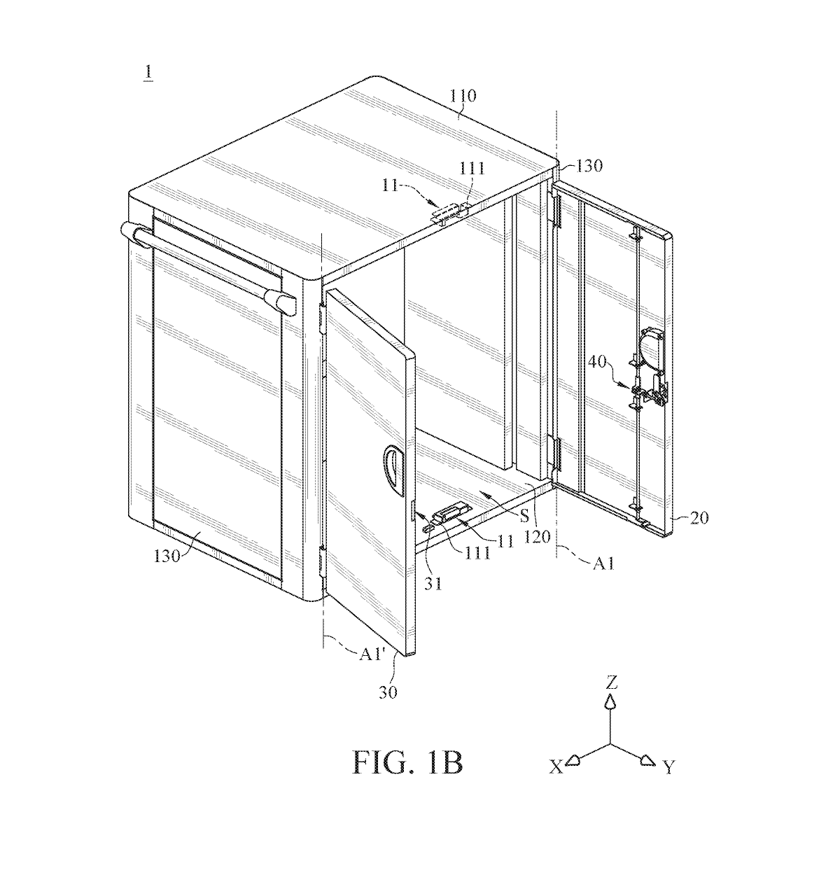

Please refer to FIGS. 1A and 1B, which are perspective views of a charging cart according to one embodiment of the disclosure. As shown in FIGS. 1A and 1B, a charging cart 1 is provided. The charging cart 1 includes a casing 10, a first door leaf 20, a second door leaf 30 and a hooking mechanism 40.

The casing 10 has a top plate 110, a bottom plate 120 and two side plates 130. The top plate 110 and the bottom plate 120 face each other. The two side plates 130 are connected to and located between the top plate 110 and the bottom plate 120. The top plate 110, the bottom plate 120 and the two side plates 130 together define an accommodating space S. The accommodating space S is for accommodating electronic devices such as tablet computers or notebook computers. In addition, in this embodiment, the casing 10 has two first hooking slots 11. The two first hooking slots 11 are respectively located on the top plate 110 and the bottom plate 120 of the casing 10. Specifically, there are two eyes 111 respectively disposed on an inner surface of the top plate 110 and an inner surface of the bottom plate 120. The two first hooking slots 11 are formed on the two eyes 111, respectively. However, the present disclosure is not limited to the configuration and the quantity of the eyes 111. In addition, the present disclosure is not limited to the quantity of the first hooking slots 11. In other embodiments, the quantity of the first hooking slot 11 can be one.

The first door leaf 20 and the second door leaf 30 are pivotally mounted to the two side plates 130 of the casing 10, respectively. The first door leaf 20 is rotatable relative to the casing 10 about a first rotation axis A1. The second door leaf 30 is rotatable relative to the casing 10 about a first rotation axis A1′. Thus, the first door leaf 20 and the second door leaf 30 are able to be opened or closed relative to the casing 10. From the viewpoint of FIG. 1A or FIG. 1B, the first rotation axis A1 and the first rotation axis A1′ are parallel to the Z-axis. In addition, in this embodiment, the second door leaf 30 has a second hooking slot 31. When the first door leaf 20 and the second door leaf 30 are closed, the second hooking slot 31 is located on a side of the second door leaf 30 which faces the first door leaf 20. Furthermore, the present disclosure is not limited to the quantity of the door leafs. In other embodiments, the charging cart can have only one door leaf. In such a case, the second hooking slot 31 is located on one of the side plates 130 of the casing 10.

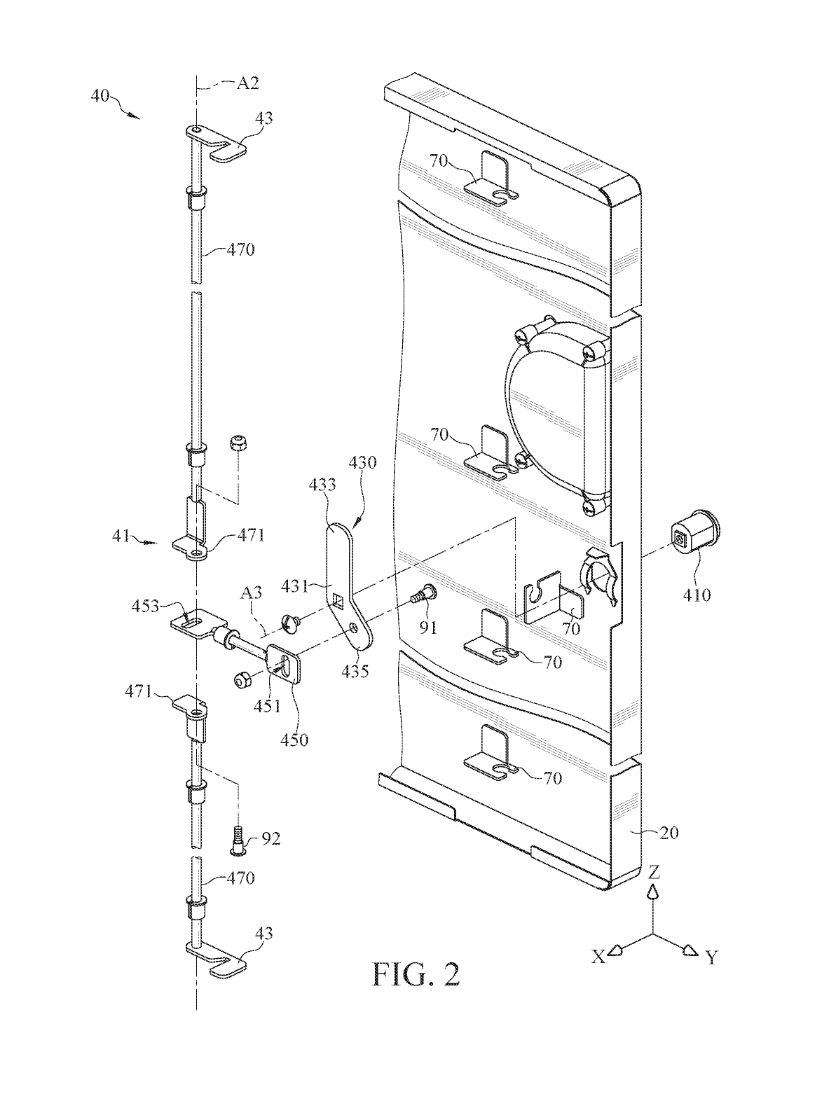

Then, please refer to FIG. 1B, and further refer to FIG. 2. FIG. 2 is a partial enlarged exploded view of the charging cart in FIG. 1B. In this embodiment, the hooking mechanism 40 includes a movable assembly 41 and two hooking members 43. The movable assembly 41 is movably disposed on the inside of the first door leaf 20. The two hooking members 43 are disposed on a top end and a bottom end of the movable assembly 41, respectively. The two hooking members 43 correspond to the two first hooking slots 11, respectively. In this embodiment, the two hooking members 43 are able to be rotated relative to the first door leaf 20 about a second rotation axis A2 by the movable assembly 41. The said second rotation axis A2 is parallel to the Z-axis.

In detail, the movable assembly 41 includes a lock 410, a rotatable member 430, a linkage 450 and two rods 470.

The lock 410 is disposed on the first door leaf 20. The lock 410 has a keyhole (not shown) on an outer surface of the first door leaf 20 for receiving a key.

The rotatable member 430 is a plate-shaped object. In this embodiment, the rotatable member 430 has a pivoting section 431, a hooking section 433 and a connecting section 435. The pivoting section 431 is connected to and located between the hooking section 433 and the connecting section 435. The pivoting section 431 is pivotally mounted to the lock 410. When the key is inserted into the keyhole of the lock 410 and then rotated, the rotatable member 430 is rotated relative to the first door leaf 20 about a third rotation axis A3 by the lock 410. The said third rotation axis A3 is parallel to the X-axis.

The linkage 450 has a first hole 451 and a second hole 453. The first hole 451 and the second hole 453 are located on two sides of the linkage 450 which are opposite to each other, respectively. A first fastener 91 fixed to the connecting section 435 of the rotatable member 430 penetrates through the first hole 451 of the linkage 450. A second fastener 92 fixed to one of the two rods 470 penetrates through the second hole 453 of the linkage 450 and is then fixed to the other one of the two rods 470. In detail, in this embodiment, each of the rods 470 has a flange 471 extending outwardly and radially from the rod 470. The end of the linkage 450 having the second hole 453 is movably located between the two flanges 471 of the two rods 470. The second fastener 92 fastens the two flanges 471 together after penetrating through the two flanges 471 and the second hole 453. The rods 470 are able to be rotated relative to the first door leaf 20 about the second rotation axis A2 by the linkage 450.

The two hooking members 43 are disposed on two sides of the two rods 470 which are opposite to each other, respectively. That is, each of the hooking members 43 is disposed on an end of the rod 470 which is opposite to the linkage 450. Thus, the hooking members 43 are able to be rotated relative to the first door leaf 20 about the second rotation axis A2 by the two rods 470. The said second rotation axis A2 is parallel to the Z-axis. In addition, the present disclosure is not limited to the quantity of the hooking members 43. In other embodiments, the quantity of the hooking member 43 can be one. Furthermore, the present disclosure is not limited to that the two rod 470 are separated from each other. In other embodiments, the two rods 470 are integrated into one piece.

Moreover, in this embodiment, the charging cart 1 further includes five positioning members 70 disposed on the inside of the first door leaf 20. The linkage 450 movably penetrates through one of the positioning members 70. The two rods 470 are movably penetrate through other two of the positioning members 70, respectively. The positioning members 70 are used for positioning the linkage 450 and the rods 470 in desired location with respect to the first door leaf 20. However, the present disclosure is not limited to the quantity of the positioning members 70. In other embodiments, the quantity of the positioning member 70 can be one.

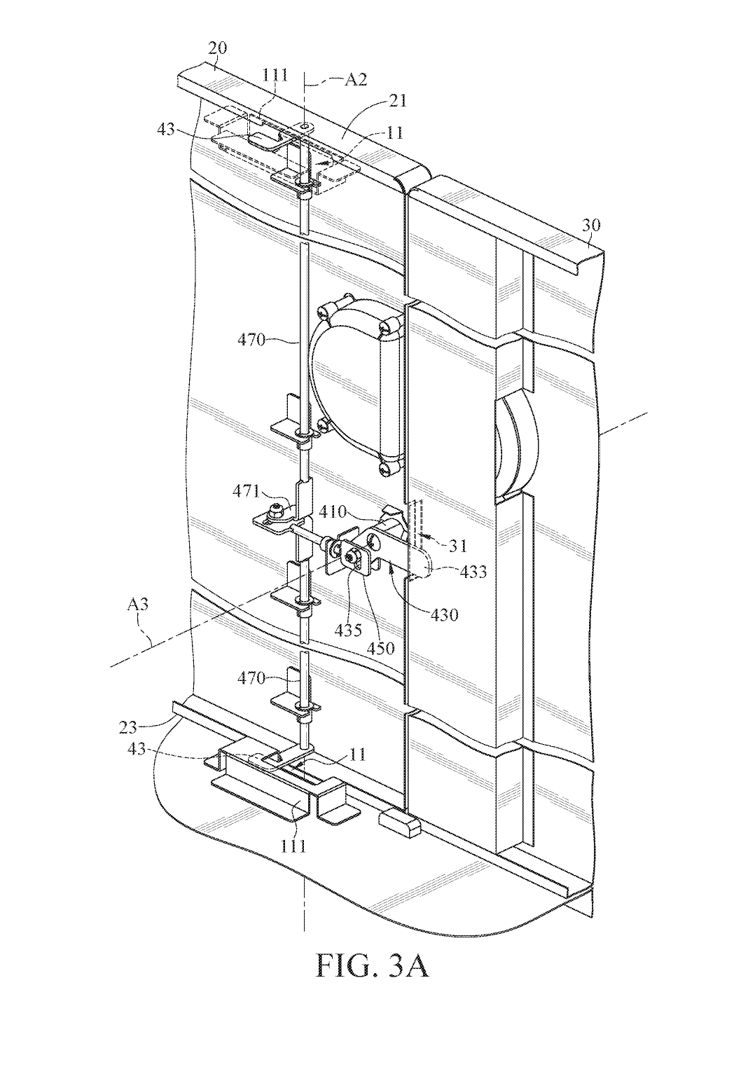

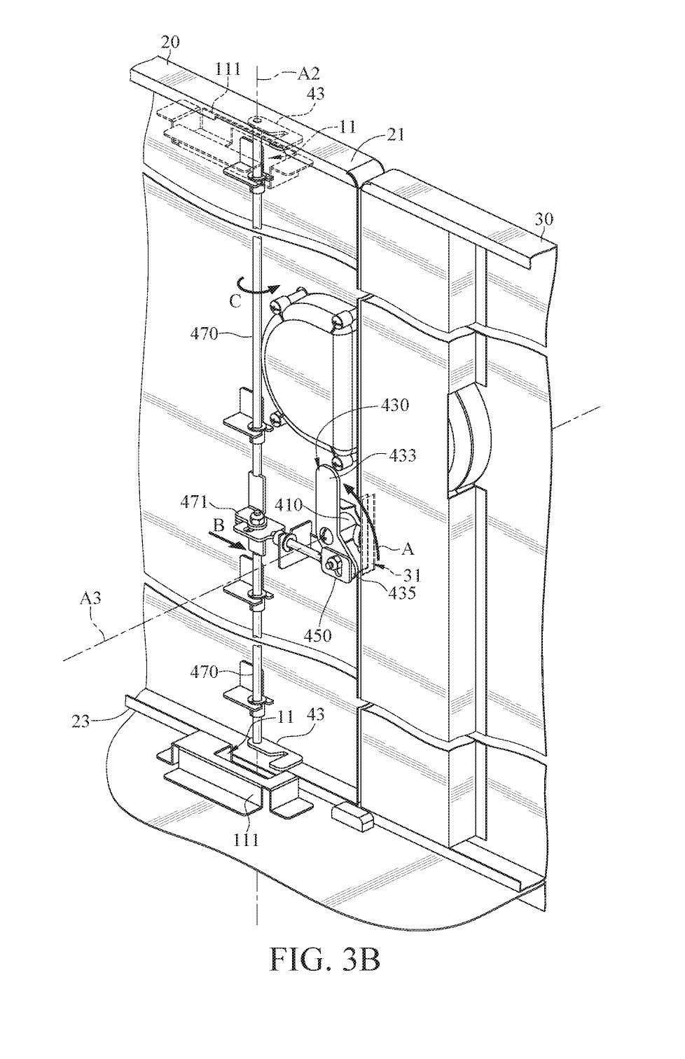

Then, the operation of the charging cart 1 is described as followings. Please refer to FIGS. 3A and 3B, FIG. 3A is a perspective view of a hooking member at a locked position according to one embodiment of the disclosure, and FIG. 3B is a perspective view of the hooking member at an unlocked position according to one embodiment of the disclosure. It is noted that the viewpoints of the FIGS. 3A and 3B are from the inside to the outside of the casing 10.

First, as shown in FIG. 3A, each of the hooking members 43 is at a locked position. In such a case, the hooking members 43 are respectively hooked to the two first hooking slots 11 so that the first door leaf 20 is fixed to the casing 10. In addition, the hooking section 433 of the rotatable member 430 is inserted into the second hooking slot 31 of the second door leaf 30 so that the second door leaf 30 is fixed to the first door leaf 20.

Then, as shown in FIG. 3B, when each of the hooking members 43 is being moved from the locked position (as shown in FIG. 3A) to an unlocked position, the lock 410 drives the rotatable member 430 to rotate relative to the first door leaf 20 in the direction of arrow A about the third rotation axis A3. In such a case, the hooking section 433 of the rotatable member 430 is detached from the second hooking slot 31 of the second door leaf 30 as being rotated in the direction of arrow A, so the second door leaf 30 is able to be rotated relative to the first door leaf 20. At the same time, the connecting section 435 of the rotatable member 430 drives the linkage 450 to move in the direction of arrow B so as to pull the two flanges 471 of the two rods 470. Since each of the flanges 471 extends outwardly and radially from the rod 470, the two flanges 471 are able to rotate the two rods 470 relative to the first door leaf 20 in the direction of arrow C about the second rotation axis A2 when the two flanges 471 are pulled by the linkage 450. Therefore, the two hooking members 43 are rotated with the two rods 470 in the same direction of arrow C about the second rotation axis A2 to respectively be detached from the two first hooking slots 11. Hence, the first door leaf 20 is able to rotate relative to the casing 10 about the first rotation axis A1.

It is noted that the user is able to move the hooking members 43 from the unlocked position (as shown in FIG. 3B) back to the locked position (as shown in FIG. 3A) by the aforementioned steps in reversed order. For example, the first door leaf 20 and the second door leaf 30 are closed firstly. Then, the lock 410 is rotated in a reversed direction of arrow A to drive the hooking section 433 of the rotatable member 430 to insert into the second hooking slot 31 of the second door leaf 30. At the same time, the hooking members 43 are rotated in a reversed direction of arrow C about the second rotation axis A2 to respectively be hooked to the two first hooking slots 11.

According to the charging cart 1 as discussed above, since the hooking members 43 are rotatable about the second rotation axis A2 (parallel to the Z-axis) which is parallel to the first rotation axis A1 (parallel to the Z-axis) of the first door leaf 20, the hooking members 43 are not moved upwardly or downwardly during rotating. Thus, the top plate 110 and the bottom plate 120 of the casing 10 are prevented from being hit by the hooking members 43 when the hooking members 43 are moved between the locked position and the unlocked position. Hence, the casing 10 is prevented from being deformed during using the charging cart.

In addition, since the two hooking members 43 are located between a top edge 21 and a bottom edge 23 of the first door leaf 20, the two hooking members 43 do not penetrate out of the top edge 21 and the bottom edge 23 of the first door leaf 20 when they are moving. Thus, the user is prevented from being hit by the hooking members 43 when using the charging cart 1.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

1. A charging cart, comprising:
a casing;
at least one eye disposed on the casing and having at least one first hooking slot
at least one door leaf pivotally mounted to the casing so that the at least one door leaf is rotatable relative to the casing about a first rotation axis; and
a hooking mechanism, comprising:
a movable assembly movably disposed on the at least one door leaf; and
at least one hooking member connected to the movable assembly, for being driven by the movable assembly to rotate relative to the at least one door leaf about a second rotation axis to be moved between a locked position and an unlocked position, and the second rotation axis paralleling to the first rotation axis;
wherein, the at least one door leaf has a top edge and a bottom edge, the at least one hooking member is located between the top edge and the bottom edge of the at least one door leaf; when the at least one door leaf rotated relative to the casing to close the casing, and the at least one hooking member is at the locked position, the at least one eye is located between the top edge and the bottom edge of the at least one door leaf, and the at least one hooking member is hooked to the at least one first hooking slot of the at least one eye so that the at least one door leaf is fixed to the casing; and
wherein when the at least one hooking member is moved from the locked position to the unlocked position by the movable assembly in order to detach the at least one hooking member from the at least one first hooking slot, the at least one door leaf is rotatable relative to the casing.

2. (canceled)

3. The charging cart according to claim 1, wherein the movable assembly includes a lock, a rotatable member, a linkage and at least one rod, the lock is disposed on the at least one door leaf, the rotatable member has a pivoting section and a connecting section which are connected to each other, the pivoting section is pivotally mounted to the lock, and one end of the linkage is movably disposed on the connecting section, the at least one rod is movably disposed on the other end of the linkage; and when the rotatable member is rotated by the lock to drive the linkage to rotate both of the at least one rod and the at least one hooking member in order to move the at least one hooking member from the locked position to the unlocked position, the at least one hooking member is detached from the at least one first hooking slot.

4. The charging cart according to claim 3, wherein the at least one rod has a flange extending radially outwardly from the at least one rod, and the linkage is movably disposed on the flange.

5. The charging cart according to claim 3, wherein the at least one door leaf comprises a first door leaf and a second door leaf, the lock is disposed on the first door leaf, the second door leaf has a second hooking slot, the rotatable member further has an hooking section, the pivoting section is connected to and located between the hooking section and the connecting section; when the hooking member is at the locked position, the hooking section of the rotatable member is inserted into the second hooking slot of the second door leaf so that the second door leaf is fixed to the first door leaf; and when the hooking member is moved from the locked position to the unlocked position, the rotatable member is rotated by the lock to detach the hooking section from the second hooking slot of the second door leaf so that the second door leaf is rotatable relative to the first door leaf.

6. The charging cart according to claim 3, wherein a third rotation axis of the rotatable member is perpendicular to the second rotation axis of the at least one hooking member.

7. The charging cart according to claim 3, further comprising at least one positioning member disposed on the inside of the at least one door leaf, and the at least one rod movably disposed on the at least one positioning member.

8. The charging cart according to claim 7, wherein the quantity of the at least one positioning member is plural, and the linkage is disposed on one of the positioning members.

9. The charging cart according to claim 3, wherein the quantity of the at least one rod is two, the quantity of the at least one hooking member is two, and the quantity of the at least one first hooking slot is two.

10. The charging cart according to claim 9, wherein the two rods are integrated into one piece, and the two hooking members are respectively disposed on two sides of the two rods which are opposite to each other.
